(19) United States
(12) Patent Application Publication
(10) Pub. No.: US 2010/0243079 A1
(43) Pub. Date: Sep. 30, 2010

(54) PRESSURE LIMITING VALVE AND ARRANGEMENT OF A PRESSURE LIMITING VALVE FOR THE PILOT CONTROL OF A PRESSURE CONTROL VALVE

(75) Inventors: Ralph Boehm, Bodmann-Ludwigshafen (DE); Markus Moosmann, Gruenkraut (DE); Stefan Meschenmoser, Friedrichshafen (DE); Georg Gierer, Kressbronn (DE); Karlheinz Mayr, Bregenz (AT)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/676,019

(22) PCT Filed: Aug. 8, 2008
(86) PCT No.: PCT/EP2008/060445

§ 371 Date: Mar. 2, 2010

(30) Foreign Application Priority Data
Sep. 5, 2007 (DE) 10 2007 042 207.7

(51) Int. Cl. F16K 31/12

(52) U.S. Cl. 137/488

(57) ABSTRACT

An arrangement of a pressure limiting valve (1) for the pilot control of a pressure control valve of a hydraulically actuatable shifting element of a motor vehicle transmission in which the pressure limiting valve (1) is disposed such that the armature axis thereof is disposed perpendicular to at least one of the driving direction and the longitudinal axis of the vehicle.

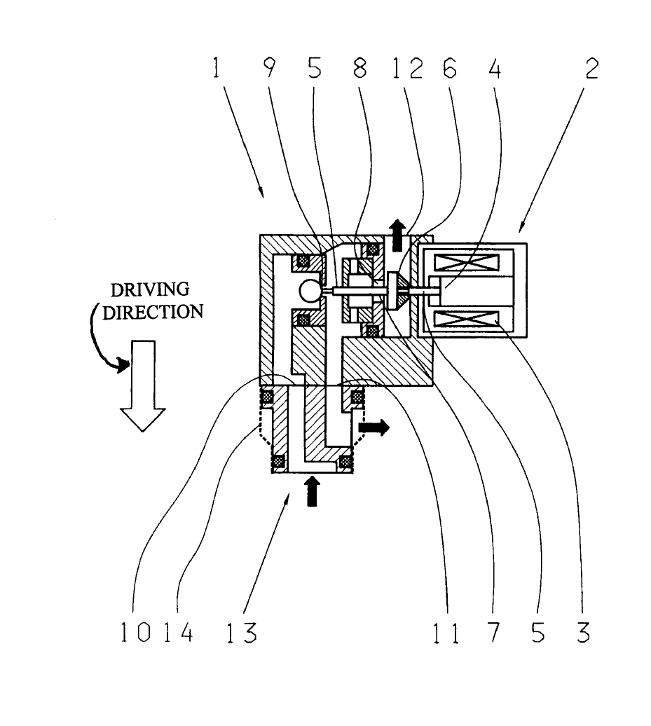

This application is a National Stage completion of PCT/EP2008/060445 filed Aug. 8, 2008, which claims priority from German patent application Ser. No. 102007 042 207.7 filed Sep. 5, 2007.

### FIELD OF THE INVENTION

The present invention relates to an arrangement of a pressure limiting valve for the pilot control of the pressure control valve of a hydraulically actuatable shifting element of a motor vehicle transmission in accordance with the invention. The invention also relates to the development of a pressure limiting valve.

### BACKGROUND OF THE INVENTION

The use of wet-running multiple disk shifting elements, to transfer torque in automatic transmissions in motor vehicles, is well known from the current status of technology.

The torque transfer occurs through frictional contact by compressing the disk packs of the shifting elements, whereby the necessary pressure on the disk pack is generated through a hydraulically actuated clutch piston that is actuated through a pressure control valve (clutch valve). The pressure control valves of the shifting elements are either directly controlled or actuated by upstream pressure limiting valves.

In both cases, a control current proportional magnetic force is generated, which adjusts the hydraulic pressure control valves of the shifting elements. The operating pressure of the clutch valves is achieved through the equilibrium condition of the control current proportional force (=actuating force) and the return force (=reaction force) of the pressure control valve.

When controlling the pressure control valves by an upstream pressure regulator and/or by an upstream pressure limiting valve (pilot pressure control valve), a so-called closed-end pressure regulator, according to the prior art, is often used, which is comprised of two valve seats that are disposed in a hydraulic half-bridge circuit, where a ball seat geometry is normally used on the supply side and a flat- or conical seat geometry is used on the tank side.

Advantageously, a closed-end pressure regulator limits oil seepage at the end positions. The intake control edge is closed when the desired minimum pressure is reached and the oil seepage, from the intake control edge to the tank edge, is thus reduced to nearly 0 ml/min. This is necessary since an actuator should ideally be directly associated with each shifting element of an automatic transmission in order to be able to represent each possible shifting transition.

Without a closed-end function, each pilot pressure control valve would exhibit maximum leakage between the supply edge and the tank edge at a minimum pressure requirement. A large number of controllable shifting elements would thus require a very significant volume of oil within the hydraulic system of the hydraulic pump.

Such a pilot pressure control valve is known, for example, from DE 10342892 A1 of the applicant. In the scope of DE 10342892 A1, a proportional pressure limiting valve with a magnet component and a valve component is described, where the valve component is equipped with a supply opening for the supply volume flow, a first discharge opening for the fill volume flow, and a second discharge opening for the tank volume flow, as well as a ball seat, a flat seat provided with an opening, a closing device for controlling the flow-through volume through the opening of the flat seat, and a stream diverter, which is positioned between the ball seat and the flat seat.

In the well-known valve, the supply opening for the supply volume flow is positioned at the front end of the valve component, facing the magnet component, in a coaxial arrangement to its longitudinal axis. The discharge openings for the fill volume flow are configured at the side wall of the valve component in a radial arrangement to its longitudinal axis, so that fluid particles that flow from the supply opening to the discharge opening are subject to a deflection of no more than 90 degrees.

From the prior art, it is also well known how to position the closed-end pressure regulator in such a manner that the armature axis is axially parallel to the crankshaft of the motor so that crankshaft vibrations, which are primarily generated by rotational irregularities of the combustion engine, are not transferred to the armature axis and the pressure regulator closing element of the pressure limiting valve. This is an effective means of preventing oscillation of the combustion engine unit from being transferred to the electrohydraulic pressure regulation of the hydraulic system.

If such pressure limiting valves are disposed in such a manner that the pressure regulator axis is in the driving direction, the disadvantage arises that during acceleration, particularly when accelerating from a starting position or when braking the vehicle, the force from the acceleration that is coupled in the pressure limiting valve can build up in the control path and lead to a significant loss of comfort.

### SUMMARY OF THE INVENTION

The object of the present invention, based on the stated prior art, is to provide an arrangement of a pressure limiting valve for pilot control of the pressure control valve of a hydraulically actuatable shifting element of a motor vehicle transmission, which will eliminate the unfavorable effects of building, acceleration-induced vibrations.

Further, a development of a pressure limiting valve is to be provided that does not require any change or modification to the geometry of the vehicle hydraulic transmission control in order to implement the invention-related arrangement.

According to these, it is proposed that the pressure limiting valve is disposed such that the armature axis thereof is disposed perpendicular to the driving direction or to the longitudinal axis of the vehicle, thus eliminating the problem of escalating acceleration-induced vibrations. The armature axis of the pressure limiting valve is preferably positioned parallel to the road plane.

It is suggested that, in order to maintain an existing geometry of the hydraulic transmission control configured according to the prior art, the pressure limiting valve, which according to the invention and in comparison with the prior art is turned by 90 degrees, is modified in such a manner that the existing connections for the supply volume flow and the fill volume flow can be used.

For this purpose, the supply opening for the supply volume flow and the discharge opening for the fill volume flow are disposed radially to the armature axis of the valve (in contrast to the valve known from DE 10342892 A1, where the supply opening for the supply volume flow is disposed parallel to the armature axis). According to an advantageous development of the invention, the valve nozzle is positioned perpendicular to the armature axis of the valve.

### BRIEF DESCRIPTION OF THE DRAWING

The invention is further explained below with reference to the attached figure, which is a schematic diagram of the arrangement, in accordance with the invention, of a pressure limiting valve for the pilot control of the pressure control valve of a hydraulically actuatable shifting element.

### DETAILED DESCRIPTION OF THE PREFERRED EMBODIMENTS

The sole Figure illustrates a pressure limiting valve 1. Such proportional pressure limiting valves are well known to persons skilled in the art. Only those components necessary to understand the invention are described below.

The pressure limiting valve 1, that serves as the pilot pressure control valve, has a magnetic component and/or an electromagnet 2 which, in a conventional manner, has a magnetic core, a solenoid 3, and a displaceable magnetic armature 4, as well as an actuating device 5, displaceable by the magnetic armature 4, for a closing device 6, which can impact a flat seat 7 and thus close a continuous opening 8 that is integrated in the flat seat 7.

Furthermore, a ball seat is designated as 9, the supply opening for the supply volume flow is designated as 10, the discharge opening for the fill volume flow for the clutch is designated as 11, and the discharge opening for the tank volume flow is designated as 12.

The driving direction and/or the longitudinal axis of the vehicle is shown in the sole Figure by means of an arrow. As shown in the sole Figure, the pressure limiting valve 1 is positioned in such a manner that its armature axis is disposed perpendicular to the driving direction and/or the longitudinal axis of the vehicle, which eliminates the effects of the acceleration-induced vibrations on the pressure regulation.

It is suggested that in order to maintain an existing geometry of the hydraulic transmission control in accordance with the prior art, the pressure limiting valve 1, which according to the invention and when compared with the prior art, is turned by 90 degrees, is modified in such a manner that the existing connections of the hydraulic transmission control for the supply volume flow and the fill volume flow can be used.

As shown in the sole Figure, for this purpose the supply opening 10 of the valve 1 can also be positioned radially of the armature axis, in contrast with the valve known from DE 10342892 A1. Furthermore, the valve nozzle 13 of valve 1 is positioned perpendicular to the armature axis. In the sole Figure, the mount of the transmission control that is associated with valve 1 is designated as 14 and is indicated by the broken line.

Although the arrangement according to the present invention has been explained using the example of a pilot pressure control valve with a closed-end function, valves can also be arranged and developed, according to the invention, requiring the unfavorable high oil volume that is known from the prior art, without a closed-end function.

### REFERENCE NUMERALS

1 Pressure limiting valve
2 Magnet component
3 Solenoid
4 Magnetic armature
5 Actuating device
6 Closing component
7 Flat seat
8 Opening
9 Ball seat
10 Supply opening
11 Discharge opening for the supply volume flow
12 Discharge opening for the tank volume flow
13 Valve nozzle
14 Transmission control mount

1-6. (canceled)

7. An arrangement of a pressure limiting valve (1) for pilot control of a pressure control valve of a hydraulically actuatable shifting element for a transmission of a motor vehicle, which has a combustion engine with a crankshaft being disposed parallel to a driving direction of the vehicle, whereby a discharge opening (11) of the pressure limiting valve (1) is disposed radially to an armature axis of the pressure limiting valve (1),
wherein the pressure limiting valve (1) is disposed such that the armature axis thereof is disposed perpendicular to the driving direction, whereby a supply opening (10) of the pressure limiting valve (1) is disposed radially of the armature axis, and
a valve nozzle (13) of the pressure limiting valve (1) is disposed perpendicular to the armature axis.

8. The arrangement of the pressure limiting valve (1) according to claim 7, wherein the pressure limiting valve is disposed such that the armature axis thereof is disposed parallel to a road plane.

9. The arrangement of a pressure limiting valve (1) according to claim 7, wherein a geometry of the hydraulic transmission control is not changed.
